(19) United States
(12) Patent Application Publication
(10) Pub. No.: US 2025/0379713 A1
(43) Pub. Date: Dec. 11, 2025

(54) TECHNIQUES FOR BEAM DESIGN INCORPORATING SELF-INTERFERENCE IN FULL-DUPLEX CAPABLE WIRELESS DEVICES

(71) Applicant: QUALCOMM Incorporated, San Diego, CA (US)

(72) Inventors: Vasanthan RAGHAVAN, West Windsor Township, NJ (US); Jung Ho RYU, Fort Lee, NJ (US)

(21) Appl. No.: 18/735,043

(22) Filed: Jun. 5, 2024

(51) Int. Cl. H04L 5/14; H04B 17/11

(52) U.S. Cl. CPC H04L 5/14; H04B 17/11

(57) ABSTRACT

Methods, systems, and devices for wireless communications are described in which a full-duplex capable wireless device may determine that a self-calibration for self-interference is to be performed, and may transmit a request for self-calibration resources to a network entity. The network entity may grant a set of resources for self-calibration, and provide that the granted resources are not used for communications with other wireless devices. The full-duplex capable wireless device, using the set of resources, may transmit an uplink reference signal from an uplink antenna panel, and measure received signals at its downlink antenna panel to estimate a channel matrix associated with the interference between the uplink and downlink antenna panels. The full-duplex capable wireless device may select half-duplex uplink and downlink beams, and then adjust the selected beams for full-duplex communications based on the estimated channel matrix for the interference between the uplink and downlink antenna panels.

### FIELD OF TECHNOLOGY

The following relates to wireless communications, including techniques for beam design incorporating self-interference in full-duplex capable wireless devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a full-duplex capable wireless device is described. The method may include transmitting a request for self-calibration resources for self-calibration between a first set of transmit antennas at the wireless device and a second set of receive antennas at the wireless device, receiving a resource allocation that includes the self-calibration resources, transmitting, using the first set of transmit antennas, one or more reference signals via one or more resources of the resource allocation, and determining an estimated channel matrix between the first set of transmit antennas and the second set of receive antennas based on measurements of the one or more reference signals at the second set of receive antennas.

A full-duplex capable wireless device for wireless communications is described. The full-duplex capable wireless device may include one or more memories storing processor executable code, and one or more processors coupled with the one or more memories. The one or more processors may individually or collectively be operable to execute the code to cause the full-duplex capable wireless device to transmit a request for self-calibration resources for self-calibration between a first set of transmit antennas at the wireless device and a second set of receive antennas at the wireless device, receive a resource allocation that includes the self-calibration resources, transmit, using the first set of transmit antennas, one or more reference signals via one or more resources of the resource allocation, and determine an estimated channel matrix between the first set of transmit antennas and the second set of receive antennas based on measurements of the one or more reference signals at the second set of receive antennas.

Another full-duplex capable wireless device for wireless communications is described. The full-duplex capable wireless device may include means for transmitting a request for self-calibration resources for self-calibration between a first set of transmit antennas at the wireless device and a second set of receive antennas at the wireless device, means for receiving a resource allocation that includes the self-calibration resources, means for transmitting, using the first set of transmit antennas, one or more reference signals via one or more resources of the resource allocation, and means for determining an estimated channel matrix between the first set of transmit antennas and the second set of receive antennas based on measurements of the one or more reference signals at the second set of receive antennas.

A non-transitory computer-readable medium storing code for wireless communications is described. The code may include instructions executable by one or more processors to transmit a request for self-calibration resources for self-calibration between a first set of transmit antennas at the wireless device and a second set of receive antennas at the wireless device, receive a resource allocation that includes the self-calibration resources, transmit, using the first set of transmit antennas, one or more reference signals via one or more resources of the resource allocation, and determine an estimated channel matrix between the first set of transmit antennas and the second set of receive antennas based on measurements of the one or more reference signals at the second set of receive antennas.

In some examples of the method, fulls, and non-transitory computer-readable medium described herein, the receiving the resource allocation may include operations, features, means, or instructions for receiving one or more reference signal allocations from a network entity, and where the one or more reference signals are transmitted over the one or more reference signal allocations from the first set of antennas.

Some examples of the method, fulls, and non-transitory computer-readable medium described herein may further include operations, features, means, or instructions for measuring one or more channel parameters using the one or more reference signals at the second set of antennas.

Some examples of the method, fulls, and non-transitory computer-readable medium described herein may further include operations, features, means, or instructions for determining and using an uplink beam for uplink communications and a downlink beam for downlink communications at the wireless device based on the measurements of the one or more reference signals.

In some examples of the method, fulls, and non-transitory computer-readable medium described herein, the uplink beam and the downlink beam are associated with a same transmission-reception point (TRP) or are associated with different TRPs.

Some examples of the method, fulls, and non-transitory computer-readable medium described herein may further include operations, features, means, or instructions for adjusting at least one or the uplink beam or the downlink beam based on the measurements of the one or more reference signals at the wireless device at the second set of receive antennas.

In some examples of the method, fulls, and non-transitory computer-readable medium described herein, the adjusting may include operations, features, means, or instructions for determining an adjusted downlink beam based on the estimated channel matrix between the first set of transmit antennas and the second set of receive antennas and determining an adjusted uplink beam based on the adjusted downlink beam and the estimated channel matrix between the first set of transmit antennas and the second set of receive antennas.

Some examples of the method, fulls, and non-transitory computer-readable medium described herein may further include operations, features, means, or instructions for transmitting, to a network entity, an indication of the use of an adjustment process associated with the downlink beam or the uplink beam.

In some examples of the method, fulls, and non-transitory computer-readable medium described herein, the first set of transmit antennas is associated with a first antenna panel and the second set of receive antennas is associated with a second antenna panel, and where the first antenna panel and the second antenna panel are mechanically displaceable at the wireless device.

In some examples of the method, fulls, and non-transitory computer-readable medium described herein, the first antenna panel may be movable relative to the second antenna panel, and the movement of one or more of the first antenna panel and the second antenna panel triggers a determination of the estimated channel matrix between the first set of transmit antennas and the second set of receive antennas.

In some examples of the method, fulls, and non-transitory computer-readable medium described herein, the resource allocation that includes the self-calibration resources is based on the request for self-calibration resources.

A method for wireless communications by a network entity is described. The method may include obtaining, from a full-duplex capable wireless device, a request for self-calibration resources for self-calibration between a first set of transmit antennas at the full-duplex capable wireless device and a second set of receive antennas at the full-duplex capable wireless device, determining one or more reference signal allocations based on the request for self-calibration resources, and outputting a resource allocation to the full-duplex capable wireless device that includes the self-calibration resources.

A network entity for wireless communications is described. The network entity may include one or more memories storing processor executable code, and one or more processors coupled with the one or more memories. The one or more processors may individually or collectively be operable to execute the code to cause the network entity to obtain, from a full-duplex capable wireless device, a request for self-calibration resources for self-calibration between a first set of transmit antennas at the full-duplex capable wireless device and a second set of receive antennas at the full-duplex capable wireless device, determine one or more reference signal allocations based on the request for self-calibration resources, and output a resource allocation to the full-duplex capable wireless device that includes the self-calibration resources.

Another network entity for wireless communications is described. The network entity may include means for obtaining, from a full-duplex capable wireless device, a request for self-calibration resources for self-calibration between a first set of transmit antennas at the full-duplex capable wireless device and a second set of receive antennas at the full-duplex capable wireless device, means for determining one or more reference signal allocations based on the request for self-calibration resources, and means for outputting a resource allocation to the full-duplex capable wireless device that includes the self-calibration resources.

A non-transitory computer-readable medium storing code for wireless communications is described. The code may include instructions executable by one or more processors to obtain, from a full-duplex capable wireless device, a request for self-calibration resources for self-calibration between a first set of transmit antennas at the full-duplex capable wireless device and a second set of receive antennas at the full-duplex capable wireless device, determine one or more reference signal allocations based on the request for self-calibration resources, and output a resource allocation to the full-duplex capable wireless device that includes the self-calibration resources.

Some examples of the method, network entities, and non-transitory computer-readable medium described herein may further include operations, features, means, or instructions for obtaining, from the full-duplex capable wireless device, an indication of the use of an adjustment process associated with the downlink beam or the uplink beam and communicating with the full-duplex capable wireless device using one or more adjusted beams based on the indicated adjustment process associated with the downlink beam or the uplink beam.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for beam design incorporating self-interference in full-duplex capable wireless devices in accordance with one or more aspects of the present disclosure.

FIG. 2 shows an example of a wireless communications system that supports techniques for beam design incorporating self-interference in full-duplex capable wireless devices in accordance with one or more aspects of the present disclosure.

FIG. 3 shows an example of a CPE antenna panel configuration that supports techniques for beam design incorporating self-interference in full-duplex capable wireless devices in accordance with one or more aspects of the present disclosure.

FIG. 4 shows an example of a process flow that supports techniques for beam design incorporating self-interference in full-duplex capable wireless devices in accordance with one or more aspects of the present disclosure.

FIGS. 5 and 6 show block diagrams of devices that support techniques for beam design incorporating self-interference in full-duplex capable wireless devices in accordance with one or more aspects of the present disclosure.

FIG. 7 shows a block diagram of a communications manager that supports techniques for beam design incorporating self-interference in full-duplex capable wireless devices in accordance with one or more aspects of the present disclosure.

FIG. 8 shows a diagram of a system including a device that supports techniques for beam design incorporating self-interference in full-duplex capable wireless devices in accordance with one or more aspects of the present disclosure.

FIGS. 9 and 10 show block diagrams of devices that support techniques for beam design incorporating self-interference in full-duplex capable wireless devices in accordance with one or more aspects of the present disclosure.

FIG. 11 shows a block diagram of a communications manager that supports techniques for beam design incorporating self-interference in full-duplex capable wireless devices in accordance with one or more aspects of the present disclosure.

FIG. 12 shows a diagram of a system including a device that supports techniques for beam design incorporating self-interference in full-duplex capable wireless devices in accordance with one or more aspects of the present disclosure.

FIGS. 13 through 16 show flowcharts illustrating methods that support techniques for beam design incorporating self-interference in full-duplex capable wireless devices in accordance with one or more aspects of the present disclosure.

### DETAILED DESCRIPTION

In some wireless communications systems, customers or operators may install customer premises equipment (CPE) that provide connectivity for services such as broadband, voice, and video. In some deployments, CPEs in wireless communications systems may support 4G and 5G network communications, and may be equipped with hardware and software to support the high-speed, low-latency capabilities of these networks. For example, CPEs may be used for enterprise connectivity, in which CPEs may can provide connectivity for various machines, sensors, and devices, such as in an Internet of things (IoT) deployment, and in some cases may support applications that use real-time data sharing and processing. Additionally, or alternatively, CPEs may be used to provide public or private Wi-Fi services in locations like airports, hotels, and cafes, and can support public safety networks and emergency services, offering reliable and high-speed connectivity when needed.

In some deployments, CPE systems may provide fixed wireless access (FWA) services for communications between one or more network transmission-reception points (TRPs) and one or more user equipment (UE), such as UEs located in a building or geographic area that is within a coverage area of a CPE. It is expected that full-duplex capability CPEs will be desirable to enhance spectral efficiency, decrease latency, and increase network throughput. CPEs generally have a fixed location relative to one or more serving TRPs, and thus self-interference for full-duplex communications is likely to be stable over relatively long time durations. However, there are currently no mechanisms for performing a self-calibration procedure for a CPE, or any other full-duplex capable device, to determine self-interference for full-duplex communications.

In accordance with various aspects discussed herein, a full-duplex capable wireless device, such as a CPE, may transmit a request for self-calibration resources to a network entity, and the network entity may grant a set of resources for self-calibration, and provide that the granted resources are not used at the network for communications with other wireless devices. In some cases, the full-duplex capable wireless device may transmit an uplink reference signal from an uplink antenna panel, and measure received signals at its downlink antenna panel to estimate a channel matrix associated with the interference between the uplink and downlink antenna panels. In some cases, the full-duplex capable wireless device may select a half-duplex uplink and downlink beam in accordance with traditional techniques (e.g., based on measurements of downlink reference signals from a network entity), and then adjust beams for full-duplex communications based on the estimated channel matrix for the interference between the uplink and downlink antenna panels. The full-duplex capable wireless device may use an iterative technique to adjust the beams, by first selecting an optimal uplink beam based on the half-duplex downlink beam and the estimated channel matrix, and then select an optimal downlink beam based on the optimal uplink beam and the estimated channel matrix. In some cases, the full-duplex capable wireless device may signal the full-duplex beams to the network entity for further measurement and verification. Such self-calibration at a full-duplex capable wireless device may enhance communications efficiency by allowing the device to select and adjust beams to reduce an amount of self-interference that is generated between a set of transmit antennas (e.g., a transmit antenna panel) and a set of receive antennas (e.g., a receive antenna panel) with the device operating in a full-duplex mode.

Aspects of the disclosure are initially described in the context of wireless communications systems. Aspects of the disclosure are further illustrated by and described with reference to apparatus diagrams, process flows, system diagrams, and flowcharts that relate to techniques for beam design incorporating self-interference in full-duplex capable wireless devices.

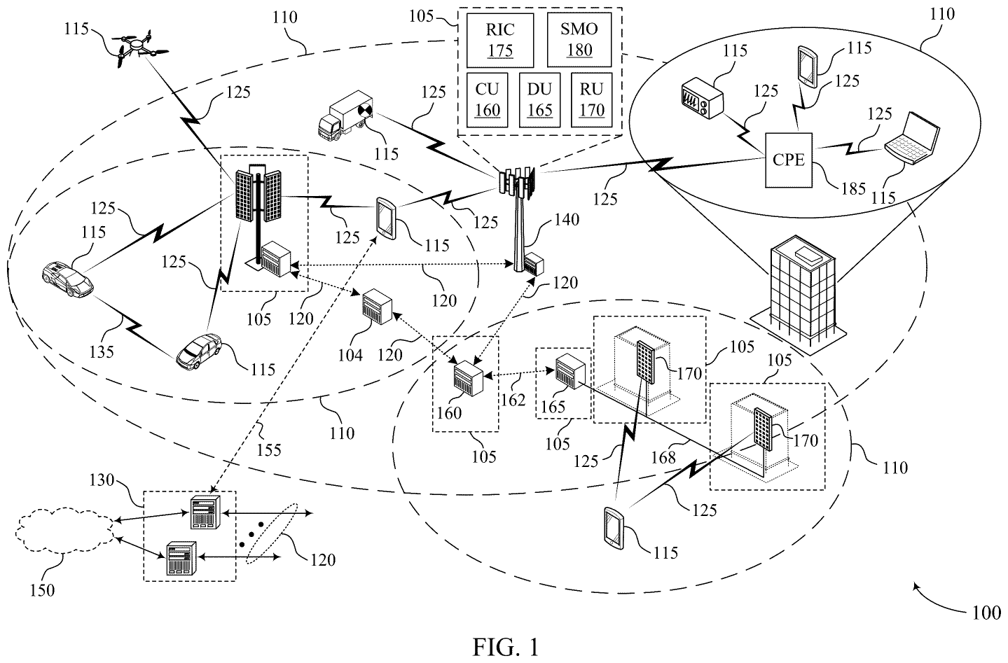

FIG. 1 shows an example of a wireless communications system 100 that supports techniques for beam design incorporating self-interference in full-duplex capable wireless devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some aspects, one or more CPEs 185, which may be examples of a full-duplex capable wireless device, may be deployed in wireless communications system 100. In some cases, one or more UEs 115 may also be examples of a full-duplex capable wireless device. In some cases, CPE 185 may determine that a self-calibration for self-interference is to be performed, and may transmit a request for self-calibration resources to a network entity 105. A network entity 105 that receives such a request may grant a set of resources for self-calibration, and provide that the granted resources are not used for communications with other wireless devices. In some cases, the CPE 185 may transmit an uplink reference signal from an uplink antenna panel, and measure received signals at its downlink antenna panel to estimate a channel matrix associated with the interference between the uplink and downlink antenna panels. In some cases, the CPE 185 may select a half-duplex uplink and downlink beam in accordance with established beam selection techniques (e.g., based on measurements of downlink reference signals from a network entity 105), and then adjust beams for full-duplex communications based on the estimated channel matrix for the interference between the uplink and downlink antenna panels. The CPE 185, in some aspects, may use an iterative technique to adjust the beams, by first selecting a favorable uplink beam based on the half-duplex downlink beam and the estimated channel matrix, and then selecting a favorable downlink beam based on the selected uplink beam and the estimated channel matrix. In some cases, the CPE 185 may signal the full-duplex beams to the network entity 105 for further measurement and verification.

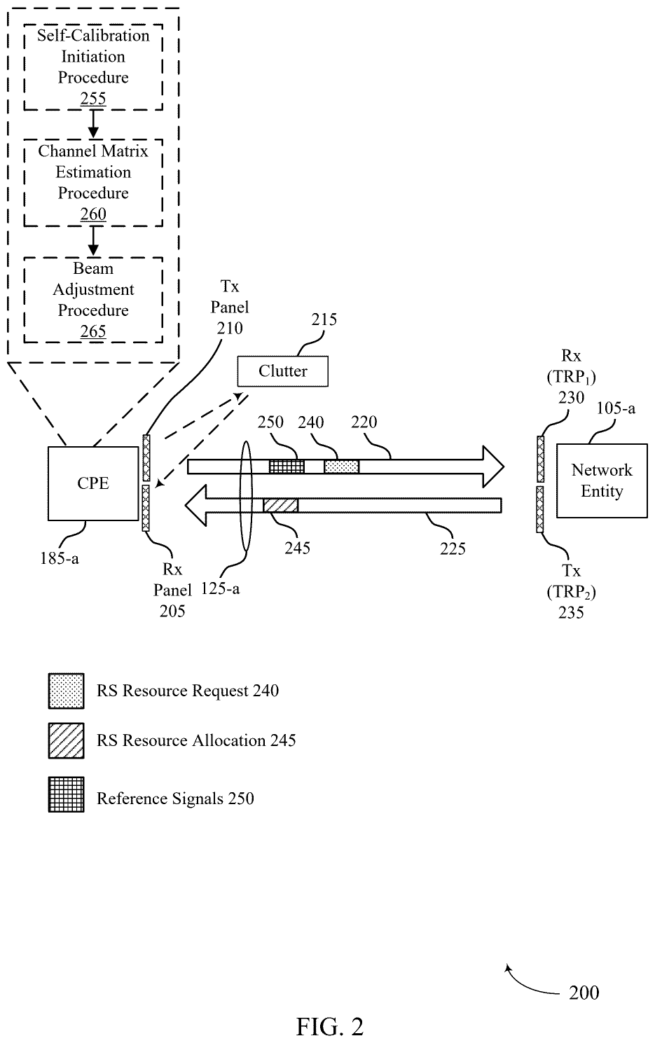

FIG. 2 shows an example of a wireless communications system 200 that supports techniques for beam design incorporating self-interference in full-duplex capable wireless devices in accordance with one or more aspects of the present disclosure. In some cases, the wireless communications system 200 may implement or be implemented by aspects of the wireless communications system 100. For example, the wireless communications system 200 may include one or more CPEs 185 (e.g., a CPE 185-a) and one or more network entities 105 (e.g., a network entity 105-a), which may be examples of the corresponding devices as described herein.

In this example, the CPE 185-a may be a full-duplex capable wireless device, and have a set of antennas that are arranged as arrays or panels, such that a subset of antennas may be a receive panel 205 and another subset of antennas may be a transmit panel 210. In some cases, the receive panel 205 and the transmit panel 210 may be physically located on separate hardware panels. In other cases the receive panel 205 and the transmit panel 210 may be physically located on a same panel. For example, each antenna array may be an array of physical antenna elements, such as an 8×8, 16×8 or 16×16 array, larger arrays for more complex implementations, or smaller arrays for lower cost implementations. When operating in a full-duplex mode, signals from the transmit panel 210 may cause interference with signals received at the receive panel 205, such as direct interference and interference due to reflections off of clutter 215, for example. In some cases, CPE 185-a select a beam for uplink communications, and considers the impact of this beam on downlink communications. However, self-interference and clutter 215 may substantially deteriorate performance in such systems without compensation.

In accordance with various techniques discussed herein, the CPE 185-a may measure self-interference, estimate a channel matrix, and select uplink and downlink beams for communications based on the estimated channel matrix. In some cases, the selected beams may be adjusted in an iterative manner, with the selected downlink beam adjusted based on the selected uplink beam and the estimated channel matrix and the selected uplink beam adjusted based on the adjusted downlink beam and the estimated channel matrix. In some aspects, these adjusted beams may then be measured for SINR performance and tested for efficacy.

In the example of FIG. 2, the CPE 185-a and network entity 105-a may communicate via link 125-a, including uplink communications 220 and downlink communications 225. The network entity 105-a may use a receive panel, or a receive TRP 230 for receiving uplink communications 220, and use a transmit panel, or a transmit TRP 235 for transmitting downlink communications 225. In this example, CPE 185-a may transmit a reference signal resource request 240 to request resources for self-calibration. The network entity 105-a may provide a reference signal resource allocation 245 to the CPE 185-a, which the CPE 185-a may use to transmit reference signals 250. The CPE 185-a may transmit the reference signal resource request 240 as part of a self-calibration initiation procedure 255. Such a procedure may be triggered, for example, based on one or more changes at the CPE 185-a (e.g., if an antenna panel is moved, if channel conditions have deteriorated indicating a change in an amount of clutter 215), based on a time since a prior calibration, or both.

In some cases, the CPE 185-a may perform beam training in a half-duplex mode for transmit panel 210 to receive TRP 230 link, and for receive panel 205 to transmit TRP 235 link. The CPE 185-a may perform a channel matrix estimation procedure 260. For example, let the corresponding beams at transmit panel 210 and receive panel 205 be denoted as g_{Panel,1} and g_{Panel,2}, respectively. Further, let the beams at receive TRP 230 and transmit TRP 235 be denoted as f_{TRP,1} and f_{TRP,2}, respectively. From the downlink of the CPE 185-a perspective, the received symbol model at receive panel 205 can be given as:

$$\text{?}$$

$$\text{?} \text{indicates text missing or illegible when filed}$$

where H_{Panel2-to-TRP2} is the channel matrix between the receive panel 205 and the transmit TRP 235, H_{Panel2-to-Panel1} is the channel matrix between the receive panel 205 and the transmit panel 210, and

$${g}_{Panel , 2}^{H} ,$$

2ⁿ is the noise. Thus, the self-interference term is

$${g}_{Panel , 2}^{H} {H}_{Panel 2 - to - Panel 1} {g}_{Panel \text{.1}} \tilde{s} .$$

In some aspects, a beam adjustment procedure 265 may then be performed based on the estimated channel matrix. The SINR associated with the full-duplex system is given as below:

$$S I N {R}_{DL} = \frac{{\vert {g}_{Panel , 2}^{H} {H}_{Panel 2 - to - TRP 2} {f}_{TRP , 2} \vert}^{2}}{1 + {\vert {g}_{Panel , 2}^{H} {H}_{Panel 2 - to - Panel 1} {g}_{Panel , 1} \vert}^{2}}$$

$$S I N {R}_{UL} = {\vert {f}_{TRP , 1}^{H} {H}_{TRP 2 - to - Panel 1} {g}_{Panel , 1} \vert}^{2}$$

A beam may be selected for uplink to maximize uplink RSRP (as seen at the receive TRP 230) and it can be determined how that selected beam impacts SINR_{DL}. This is an agnostic design and self-interference can significantly deteriorate SINR_{DL}. On the other hand, beams may be designed to maximize the sum rate on both downlink and uplink. Assuming high SINR conditions, that effectively becomes optimizing SINR_{DL}*SINR_{UL}, due to rates on the uplink and downlink may be given by:

$${log}_{2} ( 1 + S I N {R}_{DL} ) + {log}_{2} ( 1 + S I N {R}_{UL} ) \approx {log}_{2} ( 1 + S I N {R}_{DL} + S I N {R}_{UL} + S I N {R}_{DL} * S I N {R}_{UL} ) ,$$

and due to relatively high SINR values, the SINR_{DL}*SINR_{UL} is the dominant term. Thus, the sum rate may be maximize according to:

$${arg max}_{{g}_{Panel , 1} {g}_{Panel , 2}} S I N {R}_{DL} \cdot S I N {R}_{UL} = {arg max}_{{g}_{Panel , 1} {g}_{Panel , 2}} \frac{{\vert {g}_{Panel , 2}^{H} {H}_{Panel 2 - to - TRP 2} {f}_{TRP , 2} \vert}^{2} \cdot {\vert {f}_{TRP , 1}^{H} {H}_{TRP 1 - to - Panel 1} {g}_{Panel , 1} \vert}^{2}}{1 + {\vert {g}_{Panel , 2}^{H} {H}_{Panel 2 - to - Panel 1} {g}_{Panel , 1} \vert}^{2}}$$

This leads to an iterative solution. First, select g_{Panel,2} and then optimize g_{Panel,1} and vice versa according to:

$$\text{?}$$

$$\text{?}$$

$$\text{?} \text{indicates text missing or illegible when filed}$$

In some aspects, these adjusted beams may then be measured for SINR performance and tested for efficacy.

In some aspects, the CPE 185-a may be configured to transmit signals (e.g., self-calibration signals) from one panel (e.g., transmit panel 210) and receive with the other panel (e.g., receive panel 205) to learn H_{Panel1-to-Panel2}. In cases where the CPE 185-a has a fixed location, this information may not change over relatively long time-scales and thus this learning cost can be amortized over time. Thus, the CPE 185-a may request a resource allocation for panel-to-panel channel learning, and the network entity 105-a may configure specific reference signals for this learning. In some cases, the CPE 185-a may do this in an uplink mode from one of the panels where the other panel is receiving/listening to this signal. The network entity 105-a may also coordinate transmissions on its associated TRPs to not transmit over the self-calibration epochs. The CPE 185-a may use the configured resources to determine selected (e.g., optimal) beams for uplink and downlink, associated with same or different TRPs, in half-duplex (HD) mode. The CPE 185-a may then adjust the beams for full-duplex mode based on the learned learn H_{Panel2-to-Panel2} and the selected beams for uplink and downlink using the described iterative approach to incorporate self-interference. In some cases, once the full-duplex mode beams have been determined, the CPE 185-a may signal information that indicates the adjusted beams so that these beams can be used for measurement and verification of low interference.

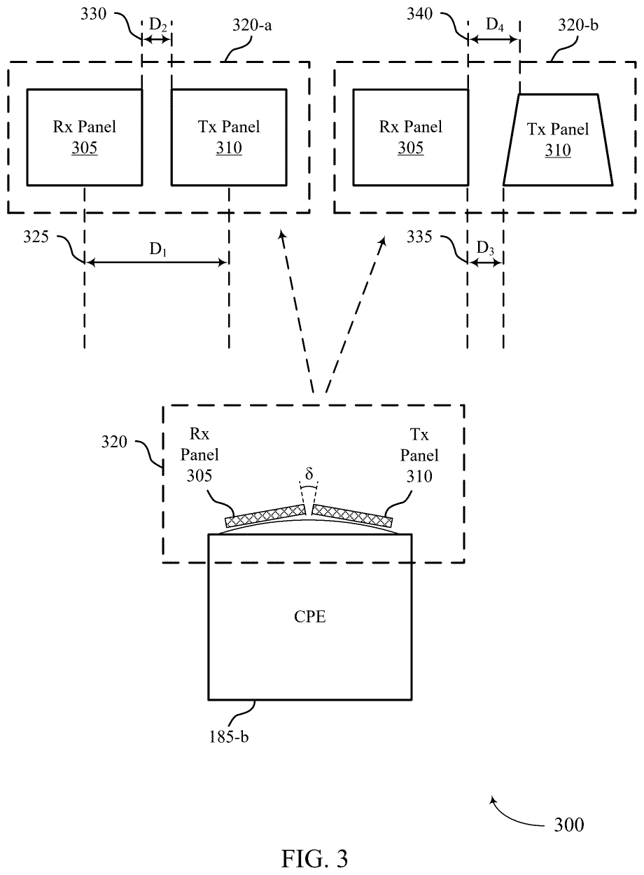

FIG. 3 shows an example of a CPE antenna panel configuration 300 that supports techniques for beam design incorporating self-interference in full-duplex capable wireless devices in accordance with one or more aspects of the present disclosure. In some cases, the CPE antenna panel configuration 300 may implement or be implemented by aspects of the wireless communications system 100, wireless communications system 200, or both. For example, the CPE antenna panel configuration 300 may be implemented by one or more CPEs 185, which may be examples of the corresponding devices as described herein.

As described herein, with reference to FIG. 2, a CPE 185-b may support self-interference calibration techniques based on panel-to-panel measurements. In some cases, such as illustrated in FIG. 3, a CPE 185-b may have an antenna panel system 320 in which physical panels, such as receive panel 305 and transmit panel 310, may be mechanically displaced. For example, receive panel 305 and transmit panel 310 may be rotatable on one or more axes, may be linearly displaced alone one or more axes, or both. In one example, the antenna panel system 320-a may provide for linear displacement between the receive panel 305 and transmit panel 310, such that a first distance 325 (D₁) between the center of the panels, and a second distance 330 (D₂) between edge elements may be changeable. Additionally, or alternatively, the antenna panel system 320-b may provide for rotation of the receive panel 305 and transmit panel 310, such that an angle δ between the receive panel 305 and transmit panel 310 is changeable. Such panel displacements may result in some misalignment between panels, such that a third distance 335 (D₃) between edge elements at a bottom of the panels is different than a fourth distance 340 (D₄) between edge elements at the top of the panels. In such scenarios, the self-calibration techniques discussed herein based on H_{Panel1-to-Panel2} may provide for adjustment of beams for the CPE 185-b to compensate for changes due to mechanical displacement. In some aspects, a change in the mechanical displacement of panels may trigger performance of the self-interference calibration procedure, and the CPE 185-b may transmit a reference signal resource request for self-calibration in such events.

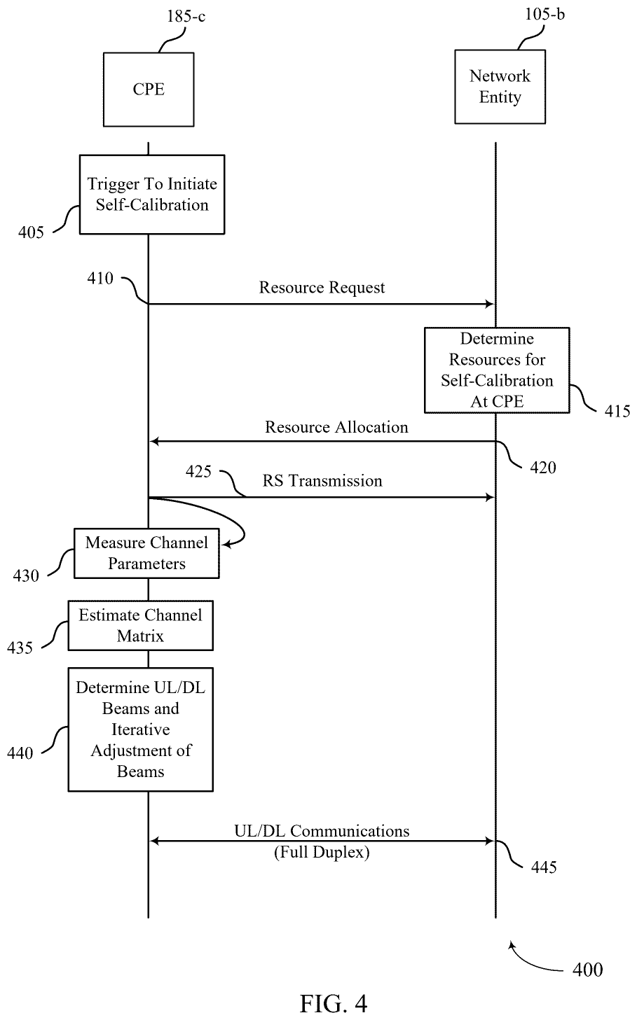

FIG. 4 shows an example of a process flow 400 that supports techniques for beam design incorporating self-interference in full-duplex capable wireless devices in accordance with one or more aspects of the present disclosure. In some cases, the process flow 400 may implement or be implemented by aspects of the wireless communications system 100, the wireless communications system 200, a CPE having CPE antenna panel configuration 300, or any combination thereof. For example, the process flow 400 may include one or more CPEs 185 (e.g., a CPE 185-c) and one or more network entities 105 (e.g., a network entity 105-b), which may be examples of the corresponding devices as described herein. In the following description of the process flow 400, the operations between the CPE 185-c and the network entity 105-b may be transmitted in a different order than the example order shown, or the operations performed by the CPE 185-c and the network entity 105-b may be performed in different orders or at different times. Some operations may also be omitted from the process flow 400, and other operations may be added to the process flow 400. Further, while various examples discussed herein are with reference to a CPE 185 that performs self-calibration, the various techniques described herein may be used at any full-duplex capable wireless device, such as a UE, a network entity, or an IAB node, to name a few examples.

At 405, the CPE 185-c may identify a trigger to initiate a self-calibration procedure. In some cases, the trigger may be a time-based trigger based on a time of a prior self-calibration procedure, may be a channel condition based trigger, may be a mechanical displacement of one or more antenna panels, or any combinations thereof.

At 410, the CPE 185-c may transmit, and the network entity 105-b may receive, a resource request. The resource request may request reference signal resource for performing a self-calibration, and may be transmitted in uplink signaling to the network entity 105-b, such as in uplink control signaling or a medium access control (MAC) control element (CE).

At 415, the network entity 105-b may determine resources for self-calibration at the CPE 185-c. In some cases, the resources may include uplink resources on one or more carriers that may be used for reference signal transmission at the CPE 185-c. In some cases, the network entity 105-b may allocate resources, and also schedule communications such that the allocated resources are not used by other panels or TRPs of the network entity 105-b.

At 420, the network entity 105-b may transmit, and the CPE 185-c may receive, resource allocation information that provides resources for a reference signal transmission of the CPE 185-c. In some cases, the resource allocation information may be provided in downlink signaling such as downlink control information that indicates the resource allocation for reference signal transmission.

At 425, the CPE 185-c may transmit one or more reference signals from a transmit panel at the CPE 185-c. In some cases, the one or more reference signals may be, for example, a sounding reference signal, a synchronization signal, or any other reference signal that may be used for measurement of channel conditions.

At 430, the CPE 185-c may measure one or more channel parameters while transmitting the one or more reference signals. For example, the CPE 185-c may measure the channel using a receive panel while a transmit panel is transmitting the one or more reference signals.

At 435, the CPE 185-c may estimate a channel matrix based on the measured channel parameters, as discussed herein. At 440, the CPE 185-c may determine one or more beams, and adjust the one or more beams based on the estimated channel matrix. Such beam determination and adjustment may be performed in accordance with various techniques as discussed herein. At 445, the CPE 185-c and network entity 105-b may perform uplink and downlink communications, which may be full-duplex communications, using the beams that were determined at the CPE 185-c.

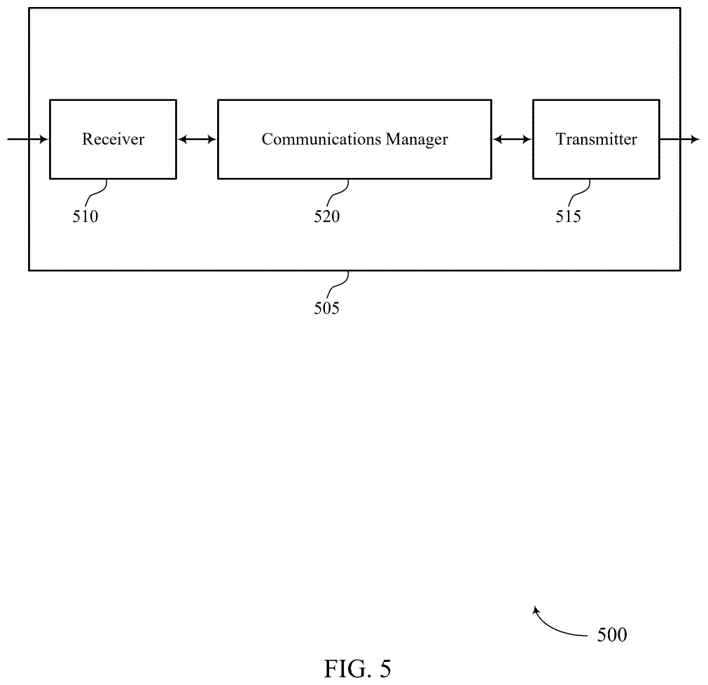

FIG. 5 shows a block diagram 500 of a device 505 that supports techniques for beam design incorporating self-interference in full-duplex capable wireless devices in accordance with one or more aspects of the present disclosure. The device 505 may be an example of aspects of a CPE 185 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for beam design incorporating self-interference in full-duplex capable wireless devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for beam design incorporating self-interference in full-duplex capable wireless devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for beam design incorporating self-interference in full-duplex capable wireless devices as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting a request for self-calibration resources for self-calibration between a first set of transmit antennas at the wireless device and a second set of receive antennas at the wireless device. The communications manager 520 is capable of, configured to, or operable to support a means for receiving a resource allocation that includes the self-calibration resources. The communications manager 520 is capable of, configured to, or operable to support a means for transmitting, using the first set of transmit antennas, one or more reference signals via one or more resources of the resource allocation. The communications manager 520 is capable of, configured to, or operable to support a means for determining an estimated channel matrix between the first set of transmit antennas and the second set of receive antennas based on measurements of the one or more reference signals at the second set of receive antennas.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for self-interference measurement, beam selection, and beam adjustment, which may provide for enhanced communications reliability, reduced power consumption, and more efficient utilization of communication resources.

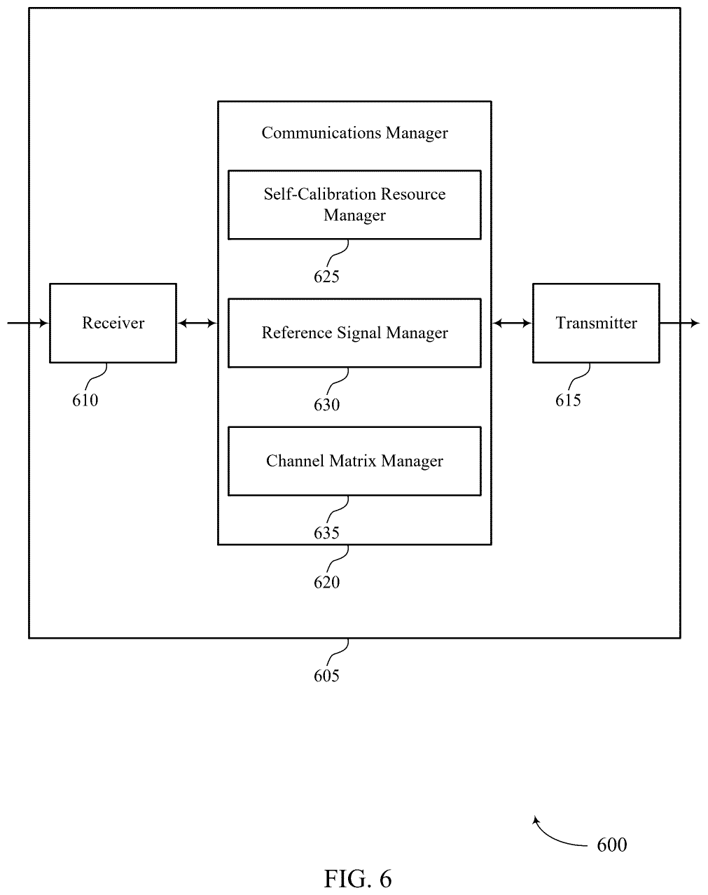

FIG. 6 shows a block diagram 600 of a device 605 that supports techniques for beam design incorporating self-interference in full-duplex capable wireless devices in accordance with one or more aspects of the present disclosure. The device 605 may be an example of aspects of a device 505 or a CPE 185 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for beam design incorporating self-interference in full-duplex capable wireless devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for beam design incorporating self-interference in full-duplex capable wireless devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for beam design incorporating self-interference in full-duplex capable wireless devices as described herein. For example, the communications manager 620 may include a self-calibration resource manager 625, a reference signal manager 630, a channel matrix manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The self-calibration resource manager 625 is capable of, configured to, or operable to support a means for transmitting a request for self-calibration resources for self-calibration between a first set of transmit antennas at the wireless device and a second set of receive antennas at the wireless device. The self-calibration resource manager 625 is capable of, configured to, or operable to support a means for receiving a resource allocation that includes the self-calibration resources. The reference signal manager 630 is capable of, configured to, or operable to support a means for transmitting, using the first set of transmit antennas, one or more reference signals via one or more resources of the resource allocation. The channel matrix manager 635 is capable of, configured to, or operable to support a means for determining an estimated channel matrix between the first set of transmit antennas and the second set of receive antennas based on measurements of the one or more reference signals at the second set of receive antennas.

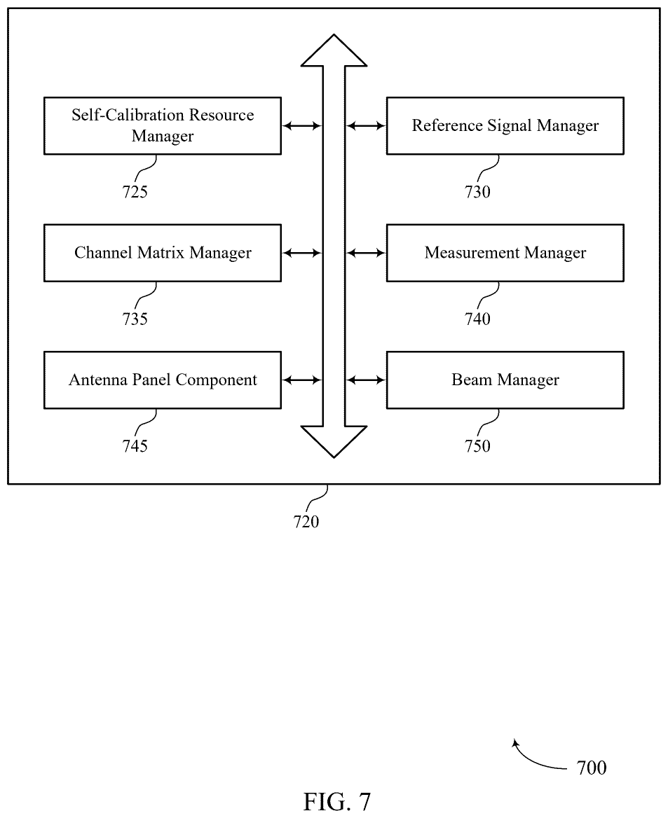

FIG. 7 shows a block diagram 700 of a communications manager 720 that supports techniques for beam design incorporating self-interference in full-duplex capable wireless devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for beam design incorporating self-interference in full-duplex capable wireless devices as described herein. For example, the communications manager 720 may include a self-calibration resource manager 725, a reference signal manager 730, a channel matrix manager 735, a measurement manager 740, an antenna panel component 745, a beam manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The self-calibration resource manager 725 is capable of, configured to, or operable to support a means for transmitting a request for self-calibration resources for self-calibration between a first set of transmit antennas at the wireless device and a second set of receive antennas at the wireless device. In some examples, the self-calibration resource manager 725 is capable of, configured to, or operable to support a means for receiving a resource allocation that includes the self-calibration resources. The reference signal manager 730 is capable of, configured to, or operable to support a means for transmitting, using the first set of transmit antennas, one or more reference signals via one or more resources of the resource allocation. The channel matrix manager 735 is capable of, configured to, or operable to support a means for determining an estimated channel matrix between the first set of transmit antennas and the second set of receive antennas based on measurements of the one or more reference signals at the second set of receive antennas.

In some examples, to support receiving the resource allocation, the self-calibration resource manager 725 is capable of, configured to, or operable to support a means for receiving one or more reference signal allocations from a network entity, and where the one or more reference signals are transmitted over the one or more reference signal allocations from the first set of antennas. In some examples, the measurement manager 740 is capable of, configured to, or operable to support a means for measuring one or more channel parameters using the one or more reference signals at the second set of antennas. In some examples, the beam manager 750 is capable of, configured to, or operable to support a means for determining and using an uplink beam for uplink communications and a downlink beam for downlink communications at the wireless device based on the measurements of the one or more reference signals. In some examples, the uplink beam and the downlink beam are associated with a same TRP or are associated with different TRPs.

In some examples, the beam manager 750 is capable of, configured to, or operable to support a means for adjusting at least one or the uplink beam or the downlink beam based on the measurements of the one or more reference signals at the wireless device at the second set of receive antennas. In some examples, to support adjusting, the beam manager 750 is capable of, configured to, or operable to support a means for determining an adjusted downlink beam based on the estimated channel matrix between the first set of transmit antennas and the second set of receive antennas. In some examples, to support adjusting, the beam manager 750 is capable of, configured to, or operable to support a means for determining an adjusted uplink beam based on the adjusted downlink beam and the estimated channel matrix between the first set of transmit antennas and the second set of receive antennas. In some examples, the beam manager 750 is capable of, configured to, or operable to support a means for transmitting, to a network entity, an indication of the use of an adjustment process associated with the downlink beam or the uplink beam. In some examples, the first set of transmit antennas are associated with a first antenna panel and the second set of receive antennas are associated with a second antenna panel, and where the first antenna panel and the second antenna panel are mechanically displaceable at the wireless device.

In some examples, the first antenna panel is movable relative to the second antenna panel, and the movement of one or more of the first antenna panel and the second antenna panel triggers a determination of the estimated channel matrix between the first set of transmit antennas and the second set of receive antennas. In some examples, the resource allocation that includes the self-calibration resources are based on the request for self-calibration resources.

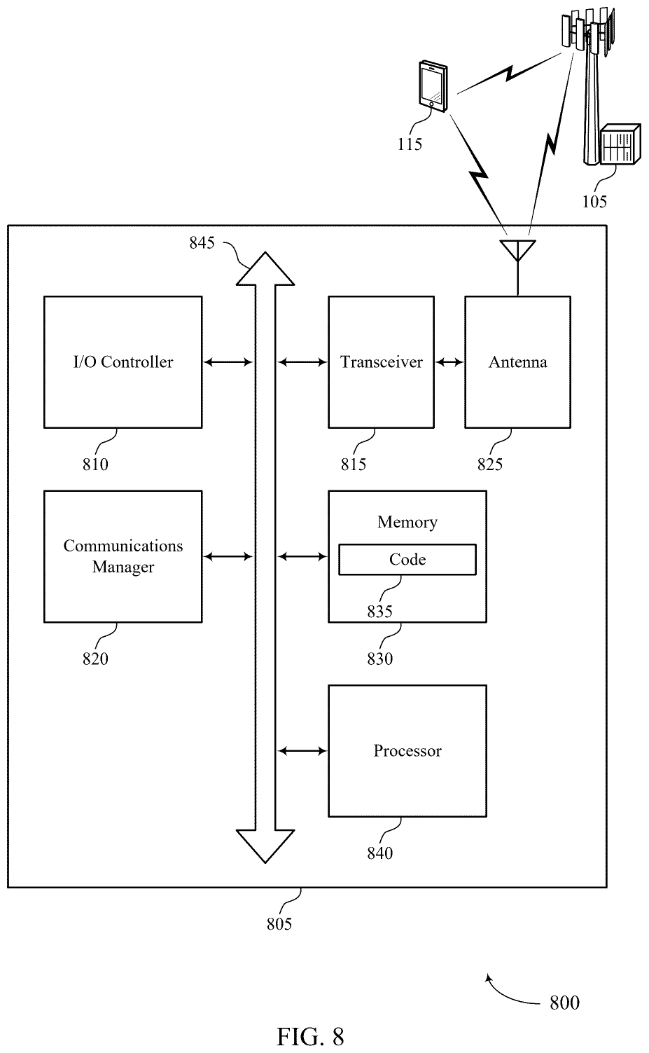

FIG. 8 shows a diagram of a system 800 including a device 805 that supports techniques for beam design incorporating self-interference in full-duplex capable wireless devices in accordance with one or more aspects of the present disclosure. The device 805 may be an example of or include components of a device 505, a device 605, or a CPE 185 as described herein. The device 805 may communicate (e.g., wirelessly) with one or more other devices (e.g., network entities 105, UEs 115, CPEs 185, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for beam design incorporating self-interference in full-duplex capable wireless devices). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting a request for self-calibration resources for self-calibration between a first set of transmit antennas at the wireless device and a second set of receive antennas at the wireless device. The communications manager 820 is capable of, configured to, or operable to support a means for receiving a resource allocation that includes the self-calibration resources. The communications manager 820 is capable of, configured to, or operable to support a means for transmitting, using the first set of transmit antennas, one or more reference signals via one or more resources of the resource allocation. The communications manager 820 is capable of, configured to, or operable to support a means for determining an estimated channel matrix between the first set of transmit antennas and the second set of receive antennas based on measurements of the one or more reference signals at the second set of receive antennas.

By including or configuring the communications manager 820 in accordance with examples as described herein, the device 805 may support techniques for self-interference measurement, beam selection, and beam adjustment, which may provide for enhanced communications reliability, reduced power consumption, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for beam design incorporating self-interference in full-duplex capable wireless devices as described herein, or the at least one processor 840 and the at least one memory 830 may be otherwise configured to, individually or collectively, perform or support such operations.

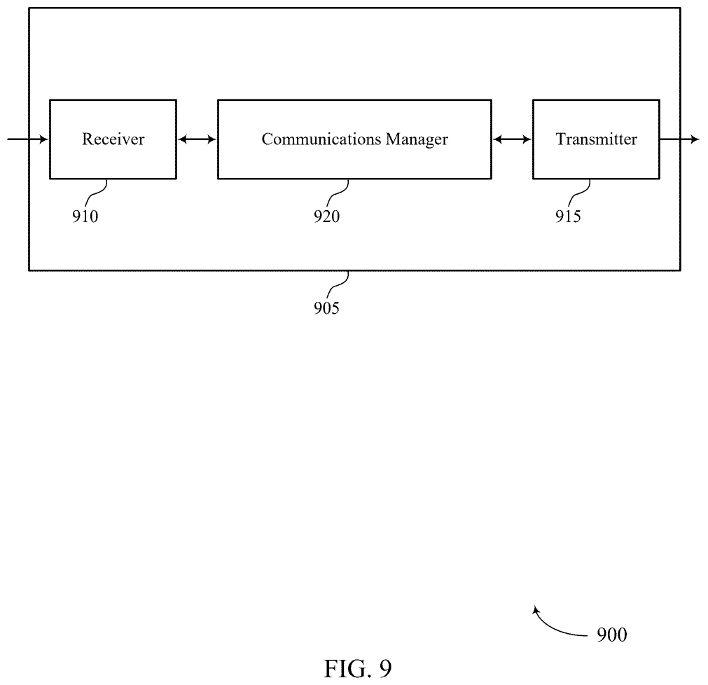

FIG. 9 shows a block diagram 900 of a device 905 that supports techniques for beam design incorporating self-interference in full-duplex capable wireless devices in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for beam design incorporating self-interference in full-duplex capable wireless devices as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for obtaining, from a full-duplex capable wireless device, a request for self-calibration resources for self-calibration between a first set of transmit antennas at the full-duplex capable wireless device and a second set of receive antennas at the full-duplex capable wireless device. The communications manager 920 is capable of, configured to, or operable to support a means for determining one or more reference signal allocations based on the request for self-calibration resources. The communications manager 920 is capable of, configured to, or operable to support a means for outputting a resource allocation to the full-duplex capable wireless device that includes the self-calibration resources.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for self-interference measurement, beam selection, and beam adjustment, which may provide for enhanced communications reliability, reduced power consumption, and more efficient utilization of communication resources.

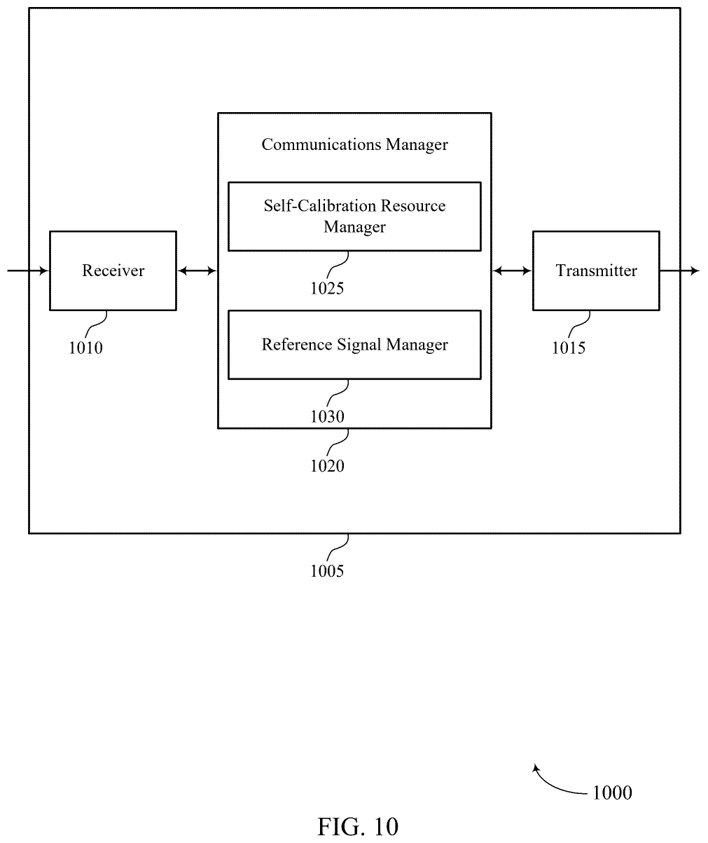

FIG. 10 shows a block diagram 1000 of a device 1005 that supports techniques for beam design incorporating self-interference in full-duplex capable wireless devices in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for beam design incorporating self-interference in full-duplex capable wireless devices as described herein. For example, the communications manager 1020 may include a self-calibration resource manager 1025 a reference signal manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The self-calibration resource manager 1025 is capable of, configured to, or operable to support a means for obtaining, from a full-duplex capable wireless device, a request for self-calibration resources for self-calibration between a first set of transmit antennas at the full-duplex capable wireless device and a second set of receive antennas at the full-duplex capable wireless device. The reference signal manager 1030 is capable of, configured to, or operable to support a means for determining one or more reference signal allocations based on the request for self-calibration resources. The self-calibration resource manager 1025 is capable of, configured to, or operable to support a means for outputting a resource allocation to the full-duplex capable wireless device that includes the self-calibration resources.

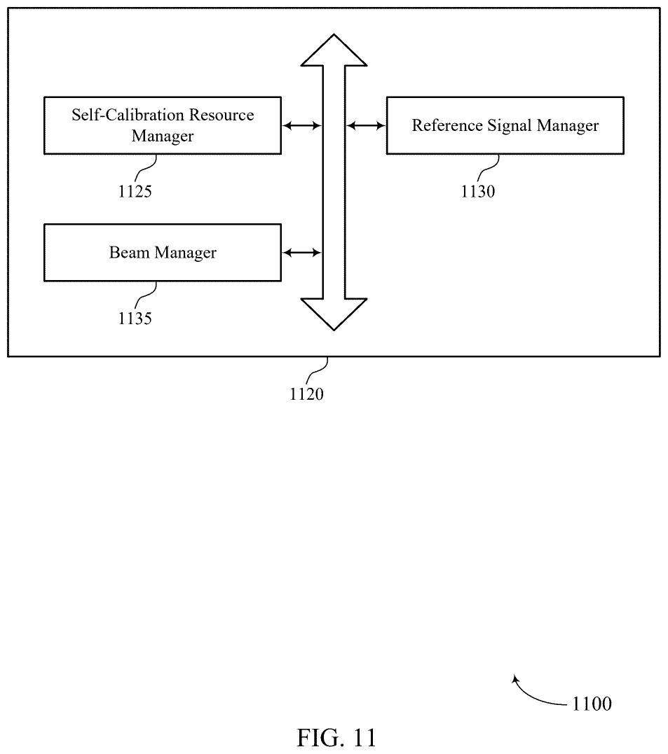

FIG. 11 shows a block diagram 1100 of a communications manager 1120 that supports techniques for beam design incorporating self-interference in full-duplex capable wireless devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for beam design incorporating self-interference in full-duplex capable wireless devices as described herein. For example, the communications manager 1120 may include a self-calibration resource manager 1125, a reference signal manager 1130, a beam manager 1135, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The self-calibration resource manager 1125 is capable of, configured to, or operable to support a means for obtaining, from a full-duplex capable wireless device, a request for self-calibration resources for self-calibration between a first set of transmit antennas at the full-duplex capable wireless device and a second set of receive antennas at the full-duplex capable wireless device. The reference signal manager 1130 is capable of, configured to, or operable to support a means for determining one or more reference signal allocations based on the request for self-calibration resources. In some examples, the self-calibration resource manager 1125 is capable of, configured to, or operable to support a means for outputting a resource allocation to the full-duplex capable wireless device that includes the self-calibration resources.

In some examples, the beam manager 1135 is capable of, configured to, or operable to support a means for obtaining, from the full-duplex capable wireless device, an indication of the use of an adjustment process associated with the downlink beam or the uplink beam. In some examples, the beam manager 1135 is capable of, configured to, or operable to support a means for communicating with the full-duplex capable wireless device using one or more adjusted beams based on the indicated adjustment process associated with the downlink beam or the uplink beam.

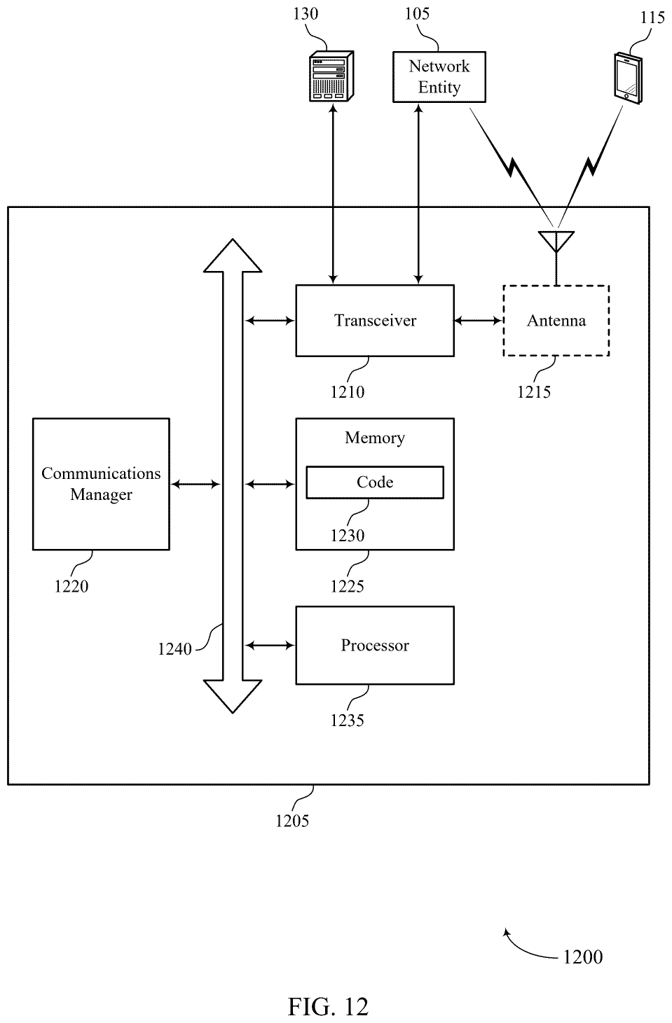

FIG. 12 shows a diagram of a system 1200 including a device 1205 that supports techniques for beam design incorporating self-interference in full-duplex capable wireless devices in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for beam design incorporating self-interference in full-duplex capable wireless devices). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for obtaining, from a full-duplex capable wireless device, a request for self-calibration resources for self-calibration between a first set of transmit antennas at the full-duplex capable wireless device and a second set of receive antennas at the full-duplex capable wireless device. The communications manager 1220 is capable of, configured to, or operable to support a means for determining one or more reference signal allocations based on the request for self-calibration resources. The communications manager 1220 is capable of, configured to, or operable to support a means for outputting a resource allocation to the full-duplex capable wireless device that includes the self-calibration resources.

By including or configuring the communications manager 1220 in accordance with examples as described herein, the device 1205 may support techniques for self-interference measurement, beam selection, and beam adjustment, which may provide for enhanced communications reliability, reduced power consumption, and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for beam design incorporating self-interference in full-duplex capable wireless devices as described herein, or the at least one processor 1235 and the at least one memory 1225 may be otherwise configured to, individually or collectively, perform or support such operations.

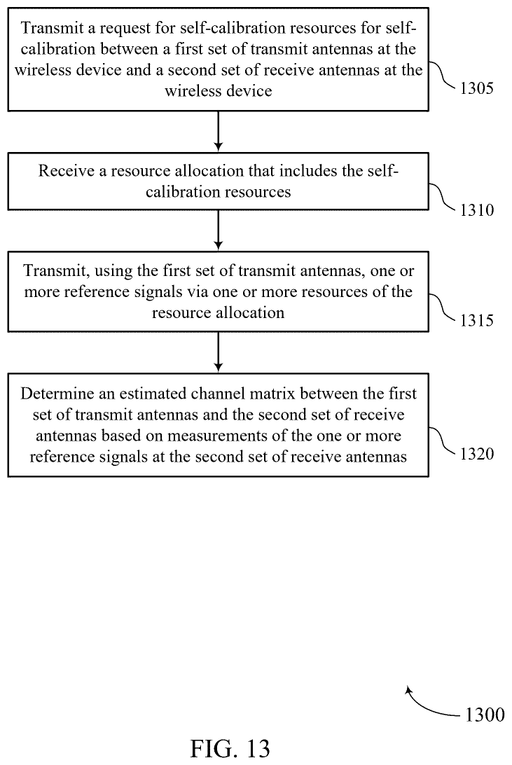

FIG. 13 shows a flowchart illustrating a method 1300 that supports techniques for beam design incorporating self-interference in full-duplex capable wireless devices in accordance with one or more aspects of the present disclosure. The operations of the method 1300 may be implemented by a CPE or its components as described herein. For example, the operations of the method 1300 may be performed by a CPE 185 as described with reference to FIGS. 1 through 8. In some examples, a CPE may execute a set of instructions to control the functional elements of the CPE to perform the described functions. Additionally, or alternatively, the CPE may perform aspects of the described functions using special-purpose hardware.

At 1305, the method may include transmitting a request for self-calibration resources for self-calibration between a first set of transmit antennas at the wireless device and a second set of receive antennas at the wireless device. The operations of 1305 may be performed in accordance with examples as disclosed herein. In some examples, aspects of the operations of 1305 may be performed by a self-calibration resource manager 725 as described with reference to FIG. 7.

At 1310, the method may include receiving a resource allocation that includes the self-calibration resources. The operations of 1310 may be performed in accordance with examples as disclosed herein. In some examples, aspects of the operations of 1310 may be performed by a self-calibration resource manager 725 as described with reference to FIG. 7.

At 1315, the method may include transmitting, using the first set of transmit antennas, one or more reference signals via one or more resources of the resource allocation. The operations of 1315 may be performed in accordance with examples as disclosed herein. In some examples, aspects of the operations of 1315 may be performed by a reference signal manager 730 as described with reference to FIG. 7.

At 1320, the method may include determining an estimated channel matrix between the first set of transmit antennas and the second set of receive antennas based on measurements of the one or more reference signals at the second set of receive antennas. The operations of 1320 may be performed in accordance with examples as disclosed herein. In some examples, aspects of the operations of 1320 may be performed by a channel matrix manager 735 as described with reference to FIG. 7.

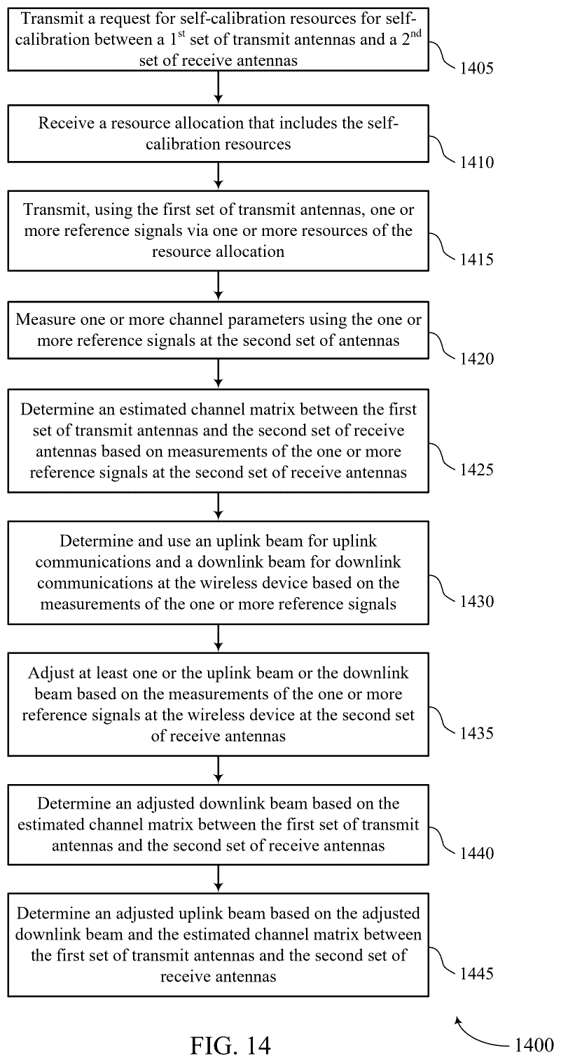

FIG. 14 shows a flowchart illustrating a method 1400 that supports techniques for beam design incorporating self-interference in full-duplex capable wireless devices in accordance with one or more aspects of the present disclosure. The operations of the method 1400 may be implemented by a CPE or its components as described herein. For example, the operations of the method 1400 may be performed by a CPE 185 as described with reference to FIGS. 1 through 8. In some examples, a CPE may execute a set of instructions to control the functional elements of the CPE to perform the described functions. Additionally, or alternatively, the CPE may perform aspects of the described functions using special-purpose hardware.

At 1405, the method may include transmitting a request for self-calibration resources for self-calibration between a first set of transmit antennas at the wireless device and a second set of receive antennas at the wireless device. The operations of 1405 may be performed in accordance with examples as disclosed herein. In some examples, aspects of the operations of 1405 may be performed by a self-calibration resource manager 725 as described with reference to FIG. 7.

At 1410, the method may include receiving a resource allocation that includes the self-calibration resources. The operations of 1410 may be performed in accordance with examples as disclosed herein. In some examples, aspects of the operations of 1410 may be performed by a self-calibration resource manager 725 as described with reference to FIG. 7.

At 1415, the method may include transmitting, using the first set of transmit antennas, one or more reference signals via one or more resources of the resource allocation. The operations of 1415 may be performed in accordance with examples as disclosed herein. In some examples, aspects of the operations of 1415 may be performed by a reference signal manager 730 as described with reference to FIG. 7.

At 1420, the method may include measuring one or more channel parameters using the one or more reference signals at the second set of antennas. The operations of 1420 may be performed in accordance with examples as disclosed herein. In some examples, aspects of the operations of 1420 may be performed by a measurement manager 740 as described with reference to FIG. 7.

At 1425, the method may include determining an estimated channel matrix between the first set of transmit antennas and the second set of receive antennas based on measurements of the one or more reference signals at the second set of receive antennas. The operations of 1425 may be performed in accordance with examples as disclosed herein. In some examples, aspects of the operations of 1425 may be performed by a channel matrix manager 735 as described with reference to FIG. 7.

At 1430, the method may include determining and using an uplink beam for uplink communications and a downlink beam for downlink communications at the wireless device based on the measurements of the one or more reference signals. The operations of 1430 may be performed in accordance with examples as disclosed herein. In some examples, aspects of the operations of 1430 may be performed by a beam manager 750 as described with reference to FIG. 7.

At 1435, the method may include adjusting at least one or the uplink beam or the downlink beam based on the measurements of the one or more reference signals at the wireless device at the second set of receive antennas. The operations of 1435 may be performed in accordance with examples as disclosed herein. In some examples, aspects of the operations of 1435 may be performed by a beam manager 750 as described with reference to FIG. 7.

At 1440, the method may include determining an adjusted downlink beam based on the estimated channel matrix between the first set of transmit antennas and the second set of receive antennas. The operations of 1440 may be performed in accordance with examples as disclosed herein. In some examples, aspects of the operations of 1440 may be performed by a beam manager 750 as described with reference to FIG. 7.

At 1445, the method may include determining an adjusted uplink beam based on the adjusted downlink beam and the estimated channel matrix between the first set of transmit antennas and the second set of receive antennas. The operations of 1445 may be performed in accordance with examples as disclosed herein. In some examples, aspects of the operations of 1445 may be performed by a beam manager 750 as described with reference to FIG. 7.

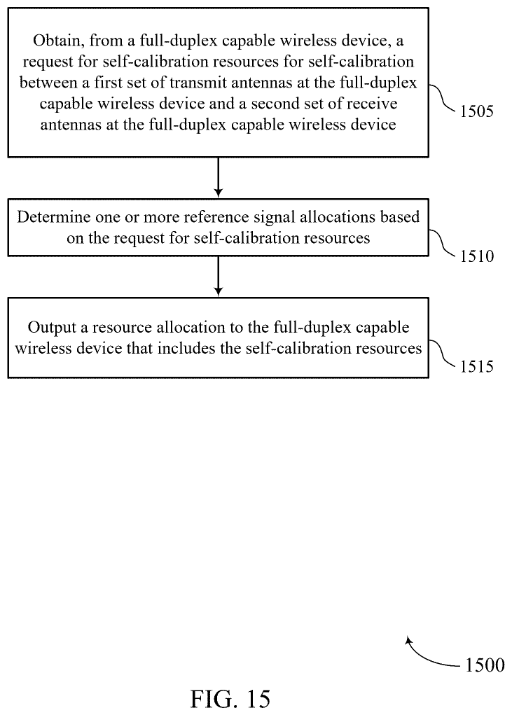

FIG. 15 shows a flowchart illustrating a method 1500 that supports techniques for beam design incorporating self-interference in full-duplex capable wireless devices in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include obtaining, from a full-duplex capable wireless device, a request for self-calibration resources for self-calibration between a first set of transmit antennas at the full-duplex capable wireless device and a second set of receive antennas at the full-duplex capable wireless device. The operations of 1505 may be performed in accordance with examples as disclosed herein. In some examples, aspects of the operations of 1505 may be performed by a self-calibration resource manager 1125 as described with reference to FIG. 11.

At 1510, the method may include determining one or more reference signal allocations based on the request for self-calibration resources. The operations of 1510 may be performed in accordance with examples as disclosed herein. In some examples, aspects of the operations of 1510 may be performed by a reference signal manager 1130 as described with reference to FIG. 11.

At 1515, the method may include outputting a resource allocation to the full-duplex capable wireless device that includes the self-calibration resources. The operations of 1515 may be performed in accordance with examples as disclosed herein. In some examples, aspects of the operations of 1515 may be performed by a self-calibration resource manager 1125 as described with reference to FIG. 11.

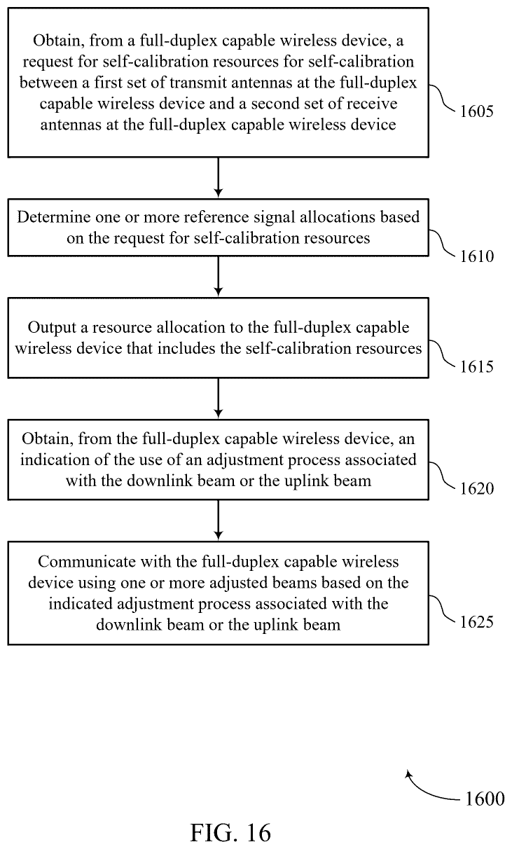

FIG. 16 shows a flowchart illustrating a method 1600 that supports techniques for beam design incorporating self-interference in full-duplex capable wireless devices in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include obtaining, from a full-duplex capable wireless device, a request for self-calibration resources for self-calibration between a first set of transmit antennas at the full-duplex capable wireless device and a second set of receive antennas at the full-duplex capable wireless device. The operations of 1605 may be performed in accordance with examples as disclosed herein. In some examples, aspects of the operations of 1605 may be performed by a self-calibration resource manager 1125 as described with reference to FIG. 11.

At 1610, the method may include determining one or more reference signal allocations based on the request for self-calibration resources. The operations of 1610 may be performed in accordance with examples as disclosed herein. In some examples, aspects of the operations of 1610 may be performed by a reference signal manager 1130 as described with reference to FIG. 11.

At 1615, the method may include outputting a resource allocation to the full-duplex capable wireless device that includes the self-calibration resources. The operations of 1615 may be performed in accordance with examples as disclosed herein. In some examples, aspects of the operations of 1615 may be performed by a self-calibration resource manager 1125 as described with reference to FIG. 11.

At 1620, the method may include obtaining, from the full-duplex capable wireless device, an indication of the use of an adjustment process associated with the downlink beam or the uplink beam. The operations of 1620 may be performed in accordance with examples as disclosed herein. In some examples, aspects of the operations of 1620 may be performed by a beam manager 1135 as described with reference to FIG. 11.

At 1625, the method may include communicating with the full-duplex capable wireless device using one or more adjusted beams based on the indicated adjustment process associated with the downlink beam or the uplink beam. The operations of 1625 may be performed in accordance with examples as disclosed herein. In some examples, aspects of the operations of 1625 may be performed by a beam manager 1135 as described with reference to FIG. 11.

The following provides an overview of aspects of the present disclosure:

Aspect 1: A method for wireless communications at a full-duplex capable wireless device, comprising: transmitting a request for self-calibration resources for self-calibration between a first set of transmit antennas at the wireless device and a second set of receive antennas at the wireless device; receiving a resource allocation that includes the self-calibration resources; transmitting, using the first set of transmit antennas, one or more reference signals via one or more resources of the resource allocation; and determining an estimated channel matrix between the first set of transmit antennas and the second set of receive antennas based at least in part on measurements of the one or more reference signals at the second set of receive antennas.

Aspect 2: The method of aspect 1, wherein the receiving the resource allocation comprises: receiving one or more reference signal allocations from a network entity, and wherein the one or more reference signals are transmitted over the one or more reference signal allocations from the first set of antennas.

Aspect 3: The method of any of aspects 1 through 2, further comprising: measuring one or more channel parameters using the one or more reference signals at the second set of antennas.

Aspect 4: The method of aspect 3, further comprising: determining and using an uplink beam for uplink communications and a downlink beam for downlink communications at the wireless device based at least in part on the measurements of the one or more reference signals.

Aspect 5: The method of aspect 4, wherein the uplink beam and the downlink beam are associated with a same transmission-reception point (TRP) or are associated with different TRPs.

Aspect 6: The method of any of aspects 4 through 5, further comprising: adjusting at least one or the uplink beam or the downlink beam based at least in part on the measurements of the one or more reference signals at the wireless device at the second set of receive antennas.

Aspect 7: The method of aspect 6, wherein the adjusting comprises: determining an adjusted downlink beam based at least in part on the estimated channel matrix between the first set of transmit antennas and the second set of receive antennas; and determining an adjusted uplink beam based at least in part on the adjusted downlink beam and the estimated channel matrix between the first set of transmit antennas and the second set of receive antennas.

Aspect 8: The method of aspect 7, further comprising: transmitting, to a network entity, an indication of the use of an adjustment process associated with the downlink beam or the uplink beam.

Aspect 9: The method of any of aspects 1 through 8, wherein the first set of transmit antennas are associated with a first antenna panel and the second set of receive antennas are associated with a second antenna panel, and wherein the first antenna panel and the second antenna panel are mechanically displaceable at the wireless device.

Aspect 10: The method of aspect 9, wherein the first antenna panel is movable relative to the second antenna panel, and the movement of one or more of the first antenna panel and the second antenna panel triggers a determination of the estimated channel matrix between the first set of transmit antennas and the second set of receive antennas.

Aspect 11: The method of any of aspects 1 through 10, wherein the resource allocation that includes the self-calibration resources are based at least in part on the request for self-calibration resources.

Aspect 12: A method for wireless communications at a network entity, comprising: obtaining, from a full-duplex capable wireless device, a request for self-calibration resources for self-calibration between a first set of transmit antennas at the full-duplex capable wireless device and a second set of receive antennas at the full-duplex capable wireless device; determining one or more reference signal allocations based at least in part on the request for self-calibration resources; and outputting a resource allocation to the full-duplex capable wireless device that includes the self-calibration resources.

Aspect 13: The method of aspect 12, further comprising: obtaining, from the full-duplex capable wireless device, an indication of the use of an adjustment process associated with the downlink beam or the uplink beam; and communicating with the full-duplex capable wireless device using one or more adjusted beams based at least in part on the indicated adjustment process associated with the downlink beam or the uplink beam.

Aspect 14: A full-duplex capable wireless device for wireless communications, comprising one or more memories storing processor-executable code, and one or more processors coupled with the one or more memories and individually or collectively operable to execute the code to cause the full-duplex capable wireless device to perform a method of any of aspects 1 through 11.

Aspect 15: A full-duplex capable wireless device for wireless communications, comprising at least one means for performing a method of any of aspects 1 through 11.

Aspect 16: A non-transitory computer-readable medium storing code for wireless communications, the code comprising instructions executable by one or more processors to perform a method of any of aspects 1 through 11.

Aspect 17: A network entity for wireless communications, comprising one or more memories storing processor-executable code, and one or more processors coupled with the one or more memories and individually or collectively operable to execute the code to cause the network entity to perform a method of any of aspects 12 through 13.

Aspect 18: A network entity for wireless communications, comprising at least one means for performing a method of any of aspects 12 through 13.

Aspect 19: A non-transitory computer-readable medium storing code for wireless communications, the code comprising instructions executable by one or more processors to perform a method of any of aspects 12 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A full-duplex capable wireless device, comprising:
one or more memories storing processor-executable code; and
one or more processors coupled with the one or more memories and individually or collectively operable to execute the code to cause the full-duplex capable wireless device to:
transmit a request for self-calibration resources for self-calibration between a first set of transmit antennas at the wireless device and a second set of receive antennas at the wireless device;
receive a resource allocation that includes the self-calibration resources;
transmit, using the first set of transmit antennas, one or more reference signals via one or more resources of the resource allocation; and
determine an estimated channel matrix between the first set of transmit antennas and the second set of receive antennas based at least in part on measurements of the one or more reference signals at the second set of receive antennas.

2. The full-duplex capable wireless device of claim 1, wherein, to receive the resource allocation, the one or more processors are individually or collectively operable to execute the code to cause the full-duplex capable wireless device to:
receive one or more reference signal allocations from a network entity, and wherein the one or more reference signals are transmitted over the one or more reference signal allocations from the first set of antennas.

3. The full-duplex capable wireless device of claim 1, wherein the one or more processors are individually or collectively further operable to execute the code to cause the full-duplex capable wireless device to:
measure one or more channel parameters using the one or more reference signals at the second set of antennas.

4. The full-duplex capable wireless device of claim 3, wherein the one or more processors are individually or collectively further operable to execute the code to cause the full-duplex capable wireless device to:
determine and use an uplink beam for uplink communications and a downlink beam for downlink communications at the wireless device based at least in part on the measurements of the one or more reference signals.

5. The full-duplex capable wireless device of claim 4, wherein the uplink beam and the downlink beam are associated with a same transmission-reception point (TRP) or are associated with different TRPs.

6. The full-duplex capable wireless device of claim 4, wherein the one or more processors are individually or collectively further operable to execute the code to cause the full-duplex capable wireless device to:
adjust at least one or the uplink beam or the downlink beam based at least in part on the measurements of the one or more reference signals at the wireless device at the second set of receive antennas.

7. The full-duplex capable wireless device of claim 6, wherein, to adjusting, the one or more processors are individually or collectively operable to execute the code to cause the full-duplex capable wireless device to:
determine an adjusted downlink beam based at least in part on the estimated channel matrix between the first set of transmit antennas and the second set of receive antennas; and
determine an adjusted uplink beam based at least in part on the adjusted downlink beam and the estimated channel matrix between the first set of transmit antennas and the second set of receive antennas.

8. The full-duplex capable wireless device of claim 7, wherein the one or more processors are individually or collectively further operable to execute the code to cause the full-duplex capable wireless device to:
transmit, to a network entity, an indication of the use of an adjustment process associated with the downlink beam or the uplink beam.

9. The full-duplex capable wireless device of claim 1, wherein the first set of transmit antennas are associated with a first antenna panel and the second set of receive antennas are associated with a second antenna panel, and wherein the first antenna panel and the second antenna panel are mechanically displaceable at the wireless device.

10. The full-duplex capable wireless device of claim 9, wherein the first antenna panel is movable relative to the second antenna panel, and movement of one or more of the first antenna panel and the second antenna panel triggers a determination of the estimated channel matrix between the first set of transmit antennas and the second set of receive antennas.

11. The full-duplex capable wireless device of claim 1, wherein the resource allocation that includes the self-calibration resources are based at least in part on the request for self-calibration resources.

12. A method for wireless communications at a full-duplex capable wireless device, comprising:
transmitting a request for self-calibration resources for self-calibration between a first set of transmit antennas at the wireless device and a second set of receive antennas at the wireless device;
receiving a resource allocation that includes the self-calibration resources;
transmitting, using the first set of transmit antennas, one or more reference signals via one or more resources of the resource allocation; and
determining an estimated channel matrix between the first set of transmit antennas and the second set of receive antennas based at least in part on measurements of the one or more reference signals at the second set of receive antennas.

13. The method of claim 12, wherein the receiving the resource allocation comprises:
receiving one or more reference signal allocations from a network entity, and wherein the one or more reference signals are transmitted over the one or more reference signal allocations from the first set of antennas.

14. The method of claim 12, further comprising:
measuring one or more channel parameters using the one or more reference signals at the second set of antennas.

15. The method of claim 14, further comprising:
determining and using an uplink beam for uplink communications and a downlink beam for downlink communications at the wireless device based at least in part on the measurements of the one or more reference signals.

16. The method of claim 15, wherein the uplink beam and the downlink beam are associated with a same transmission-reception point (TRP) or are associated with different TRPs.

17. The method of claim 15, further comprising:
adjusting at least one or the uplink beam or the downlink beam based at least in part on the measurements of the one or more reference signals at the wireless device at the second set of receive antennas.

18. The method of claim 17, wherein the adjusting comprises:
determining an adjusted downlink beam based at least in part on the estimated channel matrix between the first set of transmit antennas and the second set of receive antennas; and
determining an adjusted uplink beam based at least in part on the adjusted downlink beam and the estimated channel matrix between the first set of transmit antennas and the second set of receive antennas.

19. The method of claim 18, further comprising:
transmitting, to a network entity, an indication of the use of an adjustment process associated with the downlink beam or the uplink beam.

20. A non-transitory computer-readable medium storing code for wireless communication, the code comprising instructions executable by one or more processors to:
receive a continuous wave signal from a network entity in a resource block within a communication bandwidth, the resource block including a set of tones that span a first portion of the communication bandwidth in a frequency domain and a set of symbols that span a time period associated with the resource block in a time domain, wherein each tone of the set of tones corresponds to a different subcarrier in the frequency domain, and each symbol spans a symbol period in the time domain; and
communicate with the network entity via a backward link that includes a backscattered signal of the continuous wave signal, wherein the continuous wave signal is received in at least a first tone of the set of tones, and a location of the first tone within the set of tones is based at least in part on a midpoint frequency of the first portion of the communication bandwidth, and wherein the backscattered signal is frequency shifted within the first portion of the communication bandwidth by a frequency shift value relative to a first frequency of a first subcarrier of the first tone.
